(19) United States
(12) Patent Application Publication
(10) Pub. No.: US 2016/0354716 A1
(43) Pub. Date: Dec. 8, 2016

(54) SEPARATE FILTER BED TYPE CYLINDRICAL FILTER AND CYLINDRICAL AIR CLEANER THEREBY

(71) Applicant: Hyundai Motor Company, Seoul (KR)

(72) Inventors: Young-Gyo SEO, Suwon-si (KR); Ju-Yong LEE, Suwon-si (KR); Seong-Youn KWAK, lncheon (KR)

(73) Assignee: Hyundai Motor Company, Seoul (KR)

(21) Appl. No.: 14/948,288

(22) Filed: Nov. 21, 2015

(30) Foreign Application Priority Data
Jun. 5, 2015 (KR) 10-2015-0079696

(51) Int. Cl. B01D 46/00; B01D 46/24

(52) U.S. Cl. CPC B01D 46/001; B01D 46/0005; B01D 46/2411; B01D 2265/029; B01D 2279/60

(57) ABSTRACT

A separate filter bed cylindrical filter may include a cylindrical filer bed configured to remove foreign materials included in air, a filter bed holder punched with a plurality of holes to be introduced with air passing through the cylindrical filter bed and inserted with the cylindrical filter bed, and an upper fixing plate provided at a first end part of both end parts of the filter bed holder and contacting a first end part of both end parts of the cylindrical filter bed inserted into the filter bed holder, and a lower fixing plate coupled with a connecting end provided at a second end part of both end parts of the filter bed holder to contact a second end part of both end parts of the cylindrical filter bed and be separated from the connecting end to separate the cylindrical filter bed from the filter bed holder.

### CROSS-REFERENCE TO RELATED APPLICATIONS

The present application claims priority to Korean Patent Application No. 10-2015-0079696, filed Jun. 5, 2015, the entire contents of which is incorporated herein for all purposes by this reference.

### BACKGROUND OF THE INVENTION

Field of the Invention

Various embodiments of the present invention relate to a cylindrical air cleaner, and more particularly, to a cylindrical air cleaner by a separate filter bed type cylindrical filter to separate only a cylindrical filter bed from the cylindrical filter.

Description of Related Art

Generally, an air cleaner includes a housing which is provided with an air passage through which external air is introduced and is again discharged and a filter which is formed of a filter bed positioned in the air passage inside the housing, and removes foreign materials in the external air which is introduced into an intake system of a vehicle.

The air cleaner is classified into a quadrangular air cleaner for a car and a cylindrical air cleaner for a commercial vehicle.

Among those, the cylindrical air cleaner is applied with a cylindrical filter bed in which a laminated filter bed is wound in a circle and a cylindrical filter configured of coupling portions which are coupled with a front and a back thereof and are made of a plastic material.

However, in the cylindrical air cleaner, at the time of replacing the polluted cylindrical filter after use, the cylindrical filter is replaced bodily, and thus the plastic material which may be recycled after use as well as the cylindrical filter bed which may not be recycled after use cannot but be discarded.

In particular, at the time of replacing the cylindrical filter, the effect due to the plastic material which may not be recycled is as follows. First, unlike the cylindrical filter bed, the plastic material which may be continuously recycled is forcibly replaced and therefore a user may spend more A/S costs. Second, the coupling portion of the plastic material is produced by a mold to meet the cylindrical filter bed which is consumables, and thus the costs of the cylindrical air cleaner may be increased. Third, a lifespan of the mold may be shortened due to the excessive use of the mold for producing the coupling portion of the plastic material and the development and management costs of the mold may be increased.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY

Various aspects of the present invention are directed to providing a separate filter bed type cylindrical filter and a cylindrical air cleanser thereby capable of replacing only the polluted cylindrical filter bed after use by configuring the cylindrical filter to be detached and attached so as to separate and fix the cylindrical filter bed.

According to various aspects of the present invention, a separate filter bed cylindrical filter may include a cylindrical filer bed configured to remove foreign materials included in air, a filter bed holder punched with a plurality of holes to be introduced with air passing through the cylindrical filter bed and inserted with the cylindrical filter bed, an upper fixing plate provided at a first end part of both end parts of the filter bed holder and contacting a first end part of both end parts of the cylindrical filter bed inserted into the filter bed holder, and a lower fixing plate coupled with a connecting end provided at a second end part of both end parts of the filter bed holder to contact a second end part of both end parts of the cylindrical filter bed and be separated from the connecting end to separate the cylindrical filter bed from the filter bed holder.

A coupling and separating structure of the connecting end and the lower fixing plate may be a screw fastening scheme.

A structure of the screw fastening scheme may be a male thread formed on an outer peripheral surface of the connecting end and a female thread formed on the lower fixing plate.

A formation portion of the female thread may be an inner peripheral surface of a connecting groove formed on the lower fixing plate to insert an end portion of the connecting end.

A coupling and separating structure of the connecting end and the lower fixing plate may be a locking fitting scheme, and the structure of the locking fitting scheme may include a plurality of protruding surfaces formed at a circumference of the connecting end at a predetermined interval and a plurality of stepped surfaces formed on the lower fixing plate.

A formation portion of stepped surfaces may be a circumference of a connecting boss formed on the lower fixing plate to be inserted into the connecting end.

A coupling and separating structure of the connecting end and the lower fixing plate may be a screw fitting scheme, and a structure of the screw fitting scheme may be a female thread formed on an inner peripheral surface of the connecting end and a male thread formed on the lower fixing plate.

A formation portion of the male thread may be an outer peripheral surface of a connecting boss formed on the lower fixing plate to be inserted into the connecting end.

Both end surfaces of an upper part and a lower part of the cylindrical filter bed may be each attached with upper cylindrical paper and lower cylindrical paper to keep a shape of the cylindrical filter bed, the upper cylindrical paper may secure sealing at a contact surface between the cylindrical filter bed and the upper fixing plate, and the lower cylindrical paper may secure sealing at a contact surface between the cylindrical filter bed and the lower fixing plate.

The upper fixing plate and the lower fixing plate may be made of a plastic material.

The connecting end may be integrally formed with the filter bed holder.

According to various aspects of the present invention, a cylindrical air cleaner by a separate filter bed cylindrical filter may include a separate filter bed cylindrical filter including a filter main body into which a cylindrical filter bed removing foreign materials included in air is inserted and a lower fixing plate which is coupled with a connecting end of the filter main body to fix the cylindrical filter bed and is detached from and attached to the connecting end by at least one of a screw fastening scheme, a locking fitting scheme, and a screw fitting scheme to remove the cylindrical filter bed, a case to have the separate filter bed cylindrical filter received therein, an inlet port provided in the case to introduce external air into the case, and an outlet port provided in the case to discharge purified air from the separate filter bed cylindrical filter.

The inlet port may introduce the external air from an intake line connected to an engine and the outlet port may discharge purified air to the intake line.

It is understood that the term “vehicle” or “vehicular” or other similar terms as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g., fuel derived from resources other than petroleum). As referred to herein, a hybrid vehicle is a vehicle that has two or more sources of power, for example, both gasoline-powered and electric-powered vehicles.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a configuration diagram of an exemplary separate filter bed type cylindrical filter according to the present invention.

FIG. 2 is a detailed configuration diagram of a detachment and attachment structure of a filter main body and a lower fixing plate of the exemplary separate filter bed type cylindrical filter illustrated in FIG. 1.

FIG. 3 is a configuration diagram of an exemplary separate filter bed type cylindrical filter according to the present invention.

FIG. 4, FIG. 5, and FIG. 6 each are detailed configuration diagrams of a detachment and attachment structure of a filter main body and a lower fixing plate of the exemplary separate filter bed type cylindrical filter illustrated in FIG. 3.

FIG. 7A and FIG. 7B are configuration diagrams of a cylindrical air cleaner to which the exemplary separate filter bed type cylindrical filter according to the present invention is applied.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that the present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

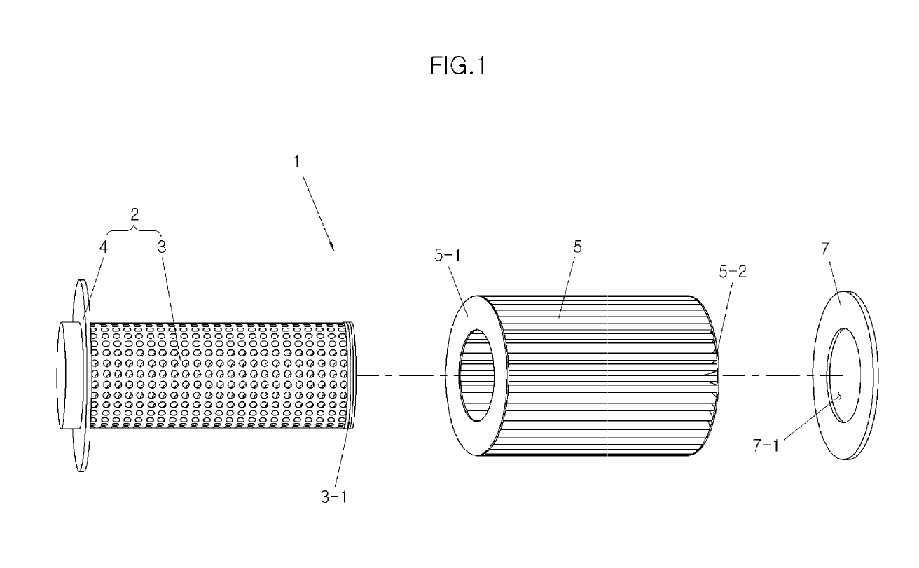

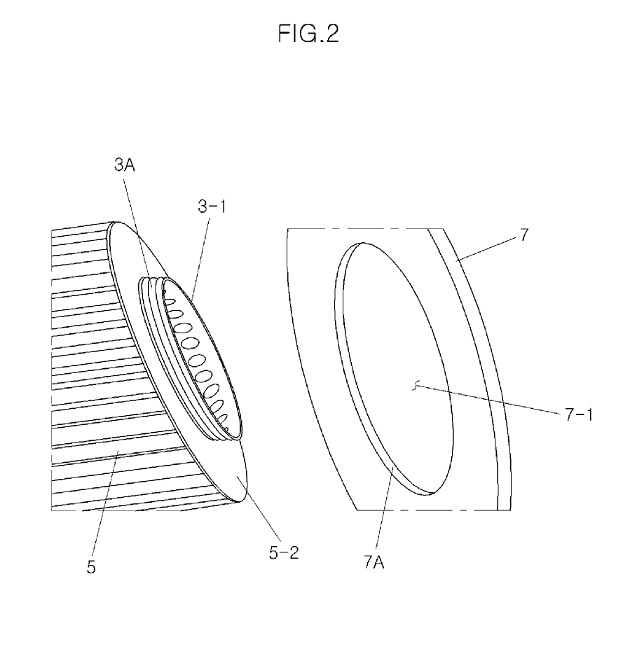

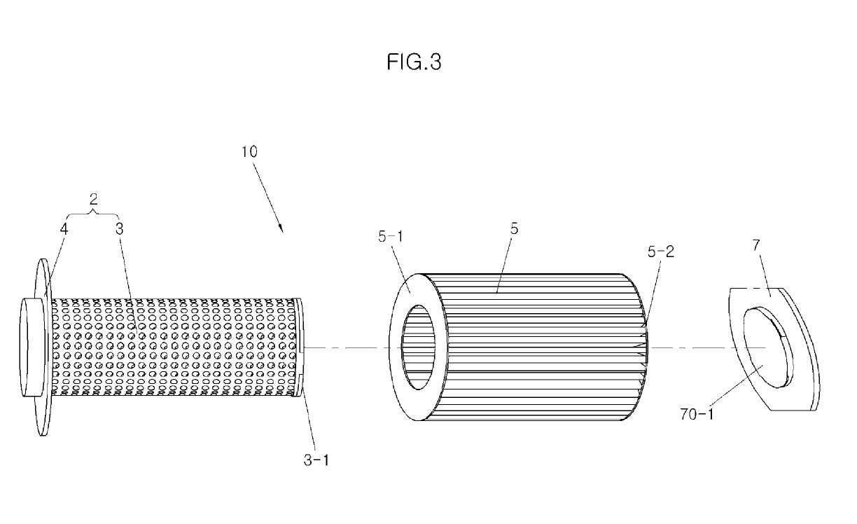

FIGS. 1 and 2 illustrate a configuration of a separate filter bed type cylindrical filter according various embodiments of the present invention.

Referring to FIG. 1, a first cylindrical filter 1 is configured to include a filter main body 2, a cylindrical filter bed 5 inserted into the filter main body 2, and a lower fixing plate 7 coupled with one part of the filter main body 2 to keep the state in which the cylindrical filter bed 5 is inserted into the filter main body 2.

In detail, the filter main body 2 is configured to include a hollow cylindrical filter bed holder 3 having a predetermined shaft length, a connecting end 3-1 provided at one end of the filter bed holder 3, and an upper fixing plate 4 provided at the filter bed holder 3 at an opposite side of the connecting end 3-1.

A hollow pillar of the filter bed holder 3 is punched with a plurality of holes through which air passes to be introduced into the hollow pillar, in which a shaft length of the hollow cylinder meets a length of the filter bed holder 3. The connecting end 3-1 is provided at an end portion of the hollow pillar of the filter bed holder 3 to form a section exposed from the cylindrical filter bed 5 inserted into the filter bed holder 3. In particular, the connecting end 3-1 is coupled with the lower fixing plate 7 in the state in which the cylindrical filter bed 5 is inserted into the filter bed holder 3 to prevent the cylindrical filter bed 5 from being separated from the filter bed holder 3. The upper fixing plate 4 is provided at the filter bed holder 3 at the opposite side of the connecting end 3-1 to prevent the cylindrical filter bed 5 inserted into the filter bed holder 3 from being separated from the filter bed holder 3. Therefore, the upper fixing plate 4 has a hat structure having a homburg. In particular, the upper fixing plate 4 is made of a plastic material and is manufactured along with the filter bed holder 3 at the time of injection molding the mold.

As the result, the air passing through the cylindrical filter bed 5 is introduced into the filter bed holder 3 through a plurality of holes punched on the filter bed holder 3 and then is again discharged through one end of the filter bed holder 3 wound with the upper fixing plate 4, to thereby exit from the filter main body 2.

The cylindrical filter bed 5 has the hollow cylindrical shape basically serving as a filter and lower cylindrical paper 5-2 is attached to a front part of the hollow cylinder and a back part of an upper cylindrical paper 5-1 to keep the hollow cylindrical shape of the cylindrical filter bed 5. In particular, the upper cylindrical paper 5-1 secures sealing at a contact surface between the upper fixing plate 4 and the cylindrical filter bed 5 and the lower cylindrical paper 5-2 secures sealing at a contact surface between the lower fixing plate 7 and the cylindrical filter bed 5.

The lower fixing plate 7 has a disk shape, a central part thereof is provided with a connecting groove 7-1, the connecting groove 7-1 has a diameter to have the connecting end 3-1 inserted thereinto to form a fixing force with the connecting end 3-1, and a depth of the connecting groove 7-1 is equal to a length of the connecting end 3-1. Therefore, the lower fixing plate 7 has a dish shape in which a central part of the lower fixing plate 7 is lowered toward the connecting groove 7-1. In particular, the lower fixing plate 7 is made of a plastic material and is manufactured by injection-molding a mold.

Meanwhile, a coupling structure between the lower fixing plate 7 and the connecting end 3-1 may be variously implemented by a fitting scheme, a press-fit scheme, a screw scheme, etc., and various embodiments of the present invention are implemented by a screw type fastening scheme.

FIG. 2 illustrates a fastening structure in which the lower fixing plate 7 and the connecting end 3-1 are fastened with each other by the screw type fastening scheme. In this case, an outer peripheral surface of the connecting end 3-1 is provided with a male thread 3A and an inner peripheral surface of a connecting groove 7-1 of the lower fixing plate 7 is provided with a female thread 7A.

Therefore, when the cylindrical filter bed 5 is inserted into the filter bed holder 3, the connecting groove 7-1 of the lower fixing plate 7 is set in the connecting end 3-1, and then the lower fixing plate 7 rotates forward (clockwise), the female thread 7A of the connecting groove 7-1 is screw-connected to the male thread 3A of the connecting end 3-1, and thus the lower fixing plate 7 is coupled with and fixed to the connecting end 3-1, such that the cylindrical filter bed 5 coupled with the filter main body 2 is restricted by the upper fixing plate 4 and the lower fixing plate, thereby performing the assembling of the first cylindrical filter 1.

On the other hand, when the lower fixing plate 7 rotates reversely (counterclockwise), the lower fixing plate 7 is separated from the connecting end 3-1 to easily separate the cylindrical filter bed 5 from the filter main body 2, thereby performing the disassembling of the first cylindrical filter 1. After the cylindrical filter bed 5 is replaced by a new cylindrical filter bed in this separating state, the lower fixing plate 7 is again screw-connected to the connecting end 3-1, such that the filter main body 2 and the lower fixing plate 7 may be recycled.

As the result, the first cylindrical filter 1 has a high recycling rate, thereby improving A/S costs and saving prime costs.

Meanwhile, FIGS. 3 to 6 illustrate a configuration of a separate filter bed type cylindrical filter according to various embodiments of the present invention.

Referring to FIG. 3, the second cylindrical filter 10 is configured to include the filter main body 2, the connecting end 3-1, the upper fixing plate 4, the cylindrical filter bed 5, and the lower fixing plate 7 which are components of the first cylindrical filter 1 illustrated in FIGS. 1 and 2. However, the second cylindrical filter 10 has a different structure from the coupling structure of the first cylindrical filter 1 in the coupling structure of the connecting end 3-1 and the lower fixing plate 7. To this end, the lower fixing plate 7 of the first cylindrical filter 1 has a dish shape toward the connecting groove 7-1, while the lower fixing plate 7 of the second cylindrical filter 10 has a protruding connecting boss 70-1, such that they have a difference in forming a double concentric circle. For example, the coupling structure between the connecting end 3-1 and the lower fixing plate 7 is based on a fitting scheme but may be variously changed.

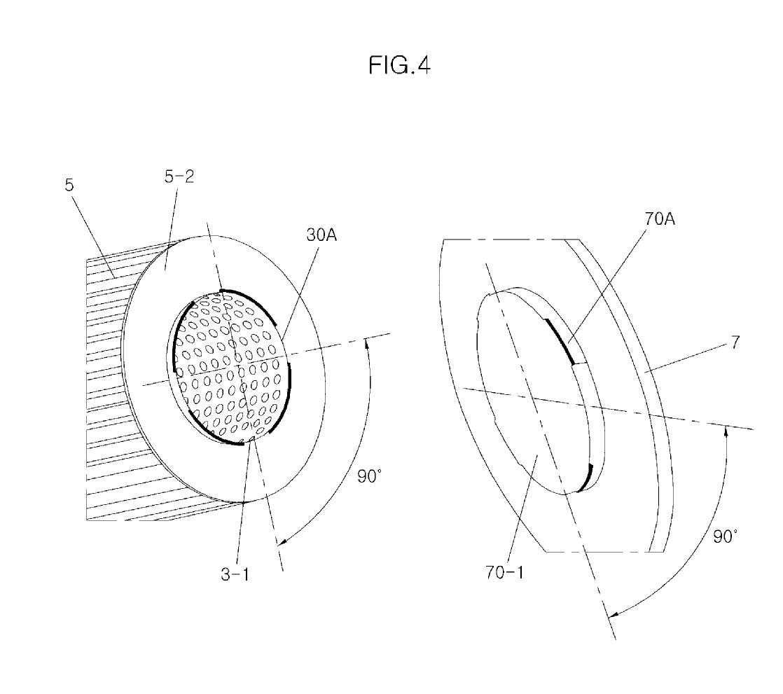

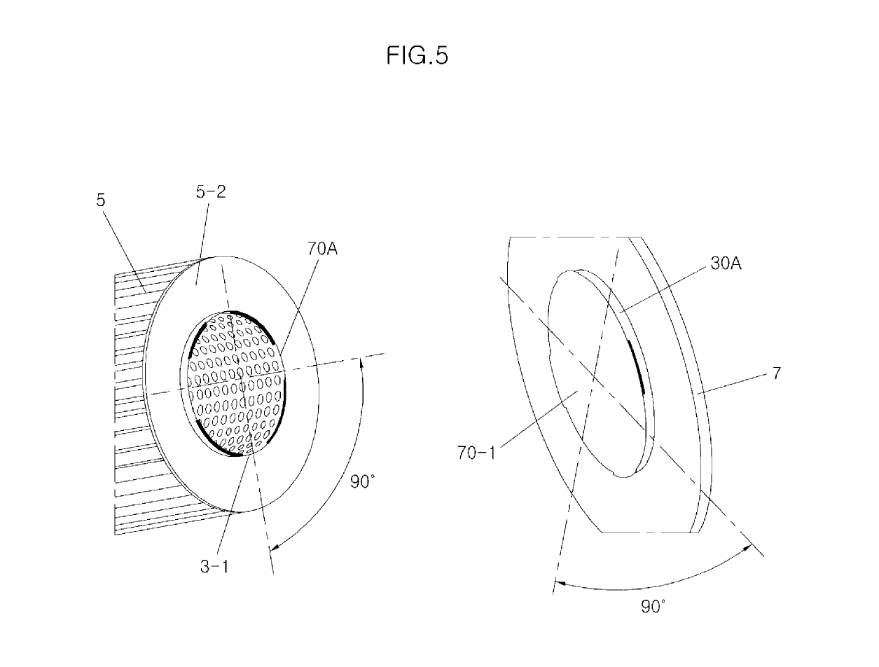

FIG. 4 illustrates that the fitting scheme of the connecting end 3-1 and the lower fixing plate 7 is an outer locking type fitting scheme. In this case, a circumference of the connecting end 3-1 is provided with a plurality of protruding surfaces 30A at a predetermined interval and a circumference of a connecting boss 70-1 protruding on the center of the lower fixing plate 7 is provided with a plurality of stepped surfaces 70A at a predetermined interval. For example, the protruding surface 30A is formed in four at an interval of 90° and the stepped surface 70A is formed in four at an interval of 90°. In particular, the protruding surface 30A forms a fixing force holding the stepped surface 70A.

FIG. 5 illustrates an inner locking type fitting scheme which is opposite to the outer locking type fitting scheme. In this case, a circumference of the connecting end 3-1 is provided with the plurality of stepped surfaces 70A at a predetermined interval and a circumference of a connecting boss 70-1 protruding on the center of the lower fixing plate 7 is provided with the plurality of protruding surfaces 30A at a predetermined interval. Therefore, the protruding surface 30A and the stepped surface 70A of the inner locking type fitting scheme have a structure which is opposite to the outer locking type fitting scheme by which the connecting end 3-1 is provided with the protruding surface 30A and the connecting boss 70-1 is provided with the stepped surface 70A, and the coupling scheme thereof is the same.

Therefore, when the cylindrical filter bed 5 is inserted into the filter bed holder 3, the connecting boss 70-1 of the lower fixing plate 7 is set in the connecting end 3-1, and then the lower fixing plate 7 is pressed toward the connecting end 3-1, the stepped surface 70A of the connecting boss 70-1 is positioned between the protruding surfaces 30A of the connecting end 3-1, such that the lower fixing plate 7 is coupled with and fixed to the connecting end 3-1. That is, when the four stepped surfaces 70A are each set to be first, second, third, fourth stepped surfaces 70A and the fourth protruding surfaces 30A are each set to be the first, second, third, and fourth protruding surfaces 30A, the first protruding surface 30A is positioned on the first stepped surface 70A, the second protruding surface 30A is positioned on the second stepped surface 70A, the third protruding surface 30A is positioned on the third stepped surface 70A, and the fourth protruding surface 30A is positioned on the fourth stepped surface 70A. Therefore, the protruding parts formed between the first and second stepped surfaces 70A are positioned at a bottom part formed between the first and second protruding surfaces 30A and are thus engaged like a rugged structure. As the result, the cylindrical filter bed 5 coupled with the filter main body 2 is restricted by the upper fixing plate 4 and the lower fixing plate 7, thereby performing the assembling of the second cylindrical filter 10.

On the other hand, when the lower fixing plate 7 is pulled from the connecting end 3-1 to separate the lower fixing plate 7, the second cylindrical filter 10 is converted into the disassembling state to easily separate the cylindrical filter bed 5 from the filter main body 2. After the cylindrical filter bed 5 is replaced by a new cylindrical filter bed in this separating state, the lower fixing plate 7 is pushed into the connecting end 3-1 and is again coupled with the connecting end 3-1, such that the filter main body 2 and the lower fixing plate 7 may be recycled.

FIG. 6 illustrates the screw type fitting scheme unlike the outer locking type fitting scheme of FIG. 4 or the inner locking type fitting scheme of FIG. 5. In this case, the inner peripheral surface of the connecting end 3-1 is provided with the female thread 7A and the outer inner peripheral surface of the connecting boss 70-1 of the lower fixing plate 70 is provided with the male thread 3A.

Therefore, when the cylindrical filter bed 5 is inserted into the filter bed holder 3, the connecting boss 70-1 of the lower fixing plate 7 is set in the connecting end 3-1, and then the lower fixing plate 7 rotates forward (clockwise), the male thread 3A of the connecting boss 70-1 is screw-connected to the female thread 7A of the connecting end 3-1, and thus the lower fixing plate 7 is coupled with and fixed to the connecting end 3-1, such that the cylindrical filter bed 5 coupled with the filter main body 2 is restricted by the upper fixing plate 4 and the lower fixing plate 7, thereby performing the assembling of the second cylindrical filter 10.

On the other hand, when the lower fixing plate 7 rotates reversely (counterclockwise), the lower fixing plate 7 is separated from the connecting end 3-1 to easily separate the cylindrical filter bed 5 from the filter main body 2, thereby performing the disassembling of the second cylindrical filter 10. After the cylindrical filter bed 5 is replaced by a new cylindrical filter bed in this separating state, the lower fixing plate 7 is again screw-connected to the connecting end 3-1, such that the filter main body 2 and the lower fixing plate 7 may be recycled.

As the result, the second cylindrical filter 10 has the high recycling rate, thereby improving the A/S costs and saving the prime costs.

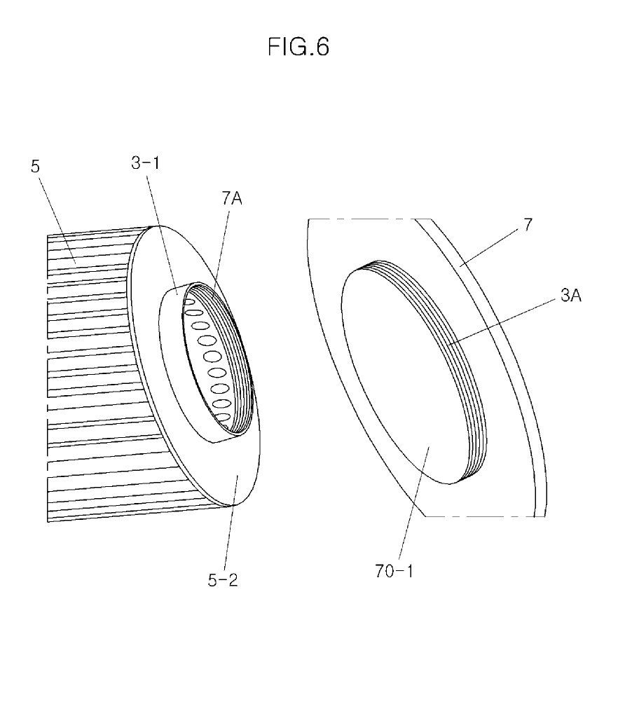

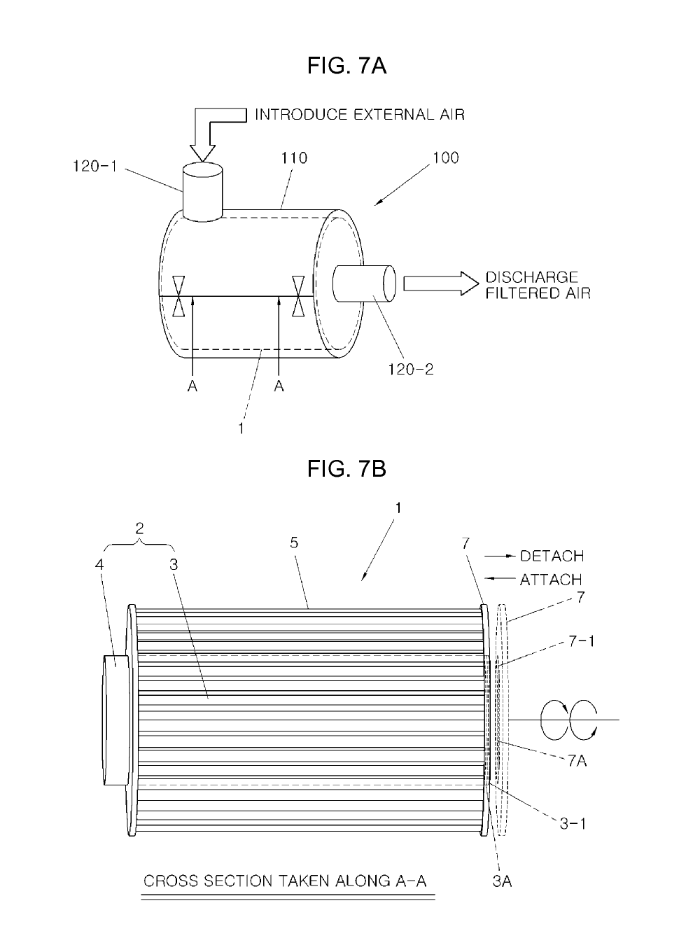

Meanwhile, FIGS. 7A and 7B illustrate a configuration of the cylindrical air cleaner to which the separate filter bed type cylindrical filter according to various embodiments of the present invention is applied.

As illustrated in FIGS. 7A and 7B, a cylindrical air cleaner 100 is configured to include a first cylindrical filter 1, a case 110 receiving the first cylindrical filter 1, an inlet port 120-1 provided in the case 110 to serve as a passage through which external air is introduced into the case 110, and an outlet port 120-2 provided in the case 110 to serve as a passage through which the purified external air is again discharged from the inside of the case 110 to the first cylindrical filter 1.

The case 110 may have an opened and closed structure to take the cylindrical filter from the case 110 at the time of replacing the cylindrical filter bed 5. The inlet port 120-1 and the outlet port 120-2 configure the intake system of the vehicle and thus are connected to an intake line introducing the external air.

When the operation of the cylindrical air cleaner 100 is performed, the external air introduced into the case 110 from the intake line through the inlet port 120-1 passes through the cylindrical filter bed 5 to be introduced into the filter bed holder 3 through the plurality of holes punched on the filter bed holder 3, exits from the filter main body 2 through the filter bed holder 3 provided with the upper fixing plate 4, and then is again discharged to the intake line through the outlet port 120-2.

In this case, the first cylindrical filter 1 is the first cylindrical filter 1 illustrated in FIGS. 1 and 2. Therefore, the first cylindrical filter 1 may be replaced by the second cylindrical filter 10 illustrated in FIGS. 3 to 6. As the result, the cylindrical air cleaner 100 uses the first cylindrical filter 1 having the high recycling rate, thereby improving the A/S costs, saving the prime costs, and improving the car makers' image.

As described above, the cylindrical air cleaner 100 according to various embodiments of the present invention is applied with the separate filter bed type cylindrical filter including the filter main body 2 into which the cylindrical filter bed 5 removing foreign materials included in air is inserted and the lower fixing plate 7 which is coupled with the connecting end 3-1 of the filter main body 2 to fix the cylindrical filter bed 5 and is detached from and attached to the connecting end by the screw type fastening scheme, the locking type fitting scheme, or the screw type fitting scheme to remove the cylindrical filter bed 6, thereby replacing only the polluted cylindrical filter bed 5 after use, improving the A/S costs by increasing the recycling of the cylindrical filter, saving the prime costs, and improving the car maker's image.

The cylindrical air cleaner according to various embodiments of the present invention has the following advantages and effects by recycling the plastic material at the time of replacing the polluted cylindrical filter bed after use.

First, in terms of the improvement of the A/S costs, only the cylindrical filter bed is replaced at the time of replacing the cylindrical filter, and therefore the costs occupied by the filter main body and the lower coupling plate, which are made of plastic and steel, may be saved. Second, in terms of the cost reduction, it is possible to increase the lifespan of the mold by reducing the usage of the mold against the manufacturing of the existing cylindrical filter in which the plastic material is discarded along with the cylindrical filter bed, in particular, it is possible to reduce the cost of the cylindrical air cleaner by saving the cost of the cylindrical filter in response to the cost saving of the mold. Third, in terms of the image improvement, it is possible to save the resources by using the recycling parts and improve the enterprise image by improving the A/S costs of the user.

For convenience in explanation and accurate definition in the appended claims, the terms “upper” or “lower”, “inner” or “outer” and etc. are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A separate filter bed cylindrical filter, comprising:
a cylindrical filer bed configured to remove foreign materials included in air;
a filter bed holder punched with a plurality of holes to be introduced with air passing through the cylindrical filter bed and inserted with the cylindrical filter bed;
an upper fixing plate provided at a first end part of both end parts of the filter bed holder and contacting a first end part of both end parts of the cylindrical filter bed inserted into the filter bed holder; and
a lower fixing plate coupled with a connecting end provided at a second end part of both end parts of the filter bed holder to contact a second end part of both end parts of the cylindrical filter bed and be separated from the connecting end to separate the cylindrical filter bed from the filter bed holder.

2. The separate filter bed cylindrical filter of claim 1, wherein a coupling and separating structure of the connecting end and the lower fixing plate is a screw fastening scheme.

3. The separate filter bed cylindrical filter of claim 2, wherein a structure of the screw fastening scheme comprises a male thread formed on an outer peripheral surface of the connecting end and a female thread formed on the lower fixing plate.

4. The separate filter bed cylindrical filter of claim 3, wherein a formation portion of the female thread is an inner peripheral surface of a connecting groove formed on the lower fixing plate to insert an end portion of the connecting end.

5. The separate filter bed cylindrical filter of claim 1, wherein a coupling and separating structure of the connecting end and the lower fixing plate is a locking fitting scheme, and
the structure of the locking fitting scheme comprises a plurality of protruding surfaces formed at a circumference of the connecting end at a predetermined interval and a plurality of stepped surfaces formed on the lower fixing plate.

6. The separate filter bed cylindrical filter of claim 5, wherein a formation portion of stepped surfaces is a circumference of a connecting boss formed on the lower fixing plate to be inserted into the connecting end.

7. The separate filter bed cylindrical filter of claim 1, wherein a coupling and separating structure of the connecting end and the lower fixing plate is a screw fitting scheme, and
a structure of the screw fitting scheme comprises a female thread formed on an inner peripheral surface of the connecting end and a male thread formed on the lower fixing plate.

8. The separate filter bed cylindrical filter of claim 7, wherein a formation portion of the male thread is an outer peripheral surface of a connecting boss formed on the lower fixing plate to be inserted into the connecting end.

9. The separate filter bed cylindrical filter of claim 1, wherein both end surfaces of an upper part and a lower part of the cylindrical filter bed are each attached with upper cylindrical paper and lower cylindrical paper to keep a shape of the cylindrical filter bed, the upper cylindrical paper secures sealing at a contact surface between the cylindrical filter bed and the upper fixing plate, and the lower cylindrical paper secures sealing at a contact surface between the cylindrical filter bed and the lower fixing plate.

10. The separate filter bed cylindrical filter of claim 1, wherein the upper fixing plate and the lower fixing plate are made of a plastic material.

11. The separate filter bed cylindrical filter of claim 1, wherein the connecting end is integrally formed with the filter bed holder.

12. A cylindrical air cleaner by a separate filter bed cylindrical filter, comprising:
a separate filter bed cylindrical filter including a filter main body into which a cylindrical filter bed removing foreign materials included in air is inserted and a lower fixing plate which is coupled with a connecting end of the filter main body to fix the cylindrical filter bed and is detached from and attached to the connecting end by at least one of a screw fastening scheme, a locking fitting scheme, and a screw fitting scheme to remove the cylindrical filter bed;
a case to have the separate filter bed cylindrical filter received therein;
an inlet port provided in the case to introduce external air into the case; and
an outlet port provided in the case to discharge purified air from the separate filter bed cylindrical filter.

13. The cylindrical air cleaner of claim 12, wherein the inlet port introduces the external air from an intake line connected to an engine and the outlet port discharges purified air to the intake line.
